(19) United States
(12) Patent Application Publication
(10) Pub. No.: US 2026/0022054 A1
(43) Pub. Date: Jan. 22, 2026

(54) GLASS MEMBER AND METHOD FOR MANUFACTURING SAME

(71) Applicant: AGC INC., Tokyo (JP)

(72) Inventors: Rui MATSUMURA, Tokyo (JP); Shuhei OGAWA, Tokyo (JP); Tomonori OGAWA, Tokyo (JP)

(21) Appl. No.: 19/339,272

(22) Filed: Sep. 24, 2025

Related U.S. Application Data
(63) Continuation of application No. PCT/JP2024/015197, filed on Apr. 16, 2024.

(30) Foreign Application Priority Data
Apr. 19, 2023 (JP) 2023-068600

(51) Int. Cl. C03C 3/095; C03C 15/00

(52) U.S. Cl. CPC C03C 3/095; C03C 15/00; C03C 2203/10

(57) ABSTRACT

Provided is a glass member for use in a semiconductor production apparatus, including hydrogen in a content of 200 ppm by mass or less. The glass member may have an average refractive index of 1.5 or more at a wavelength of 365 nm and a difference between an upper limit value and a lower limit value of a refractive index at a wavelength of 365 nm of 0.2 or less.

### CROSS-REFERENCE TO RELATED APPLICATIONS

This is a bypass continuation of International Application No. PCT/JP2024/015197 filed on Apr. 16, 2024, and claims priority from Japanese Patent Application No. 2023-068600 filed on Apr. 19, 2023, the entire content of which is incorporated herein by reference.

### TECHNICAL FIELD

The present invention relates to a glass member and a production method therefor.

### BACKGROUND ART

A member to be used in a semiconductor production apparatus is often exposed to plasma and gradually worn during the operation of the semiconductor production apparatus. The member which has been worn is replaced with a new member.

In recent years, as a product produced by the semiconductor production apparatus becomes taller and more complicated, a plasma environment to which the member is to be exposed becomes more severe, and in this case, it is frequently necessary to replace the member.

However, during the replacement of the member, the semiconductor production apparatus cannot be operated. Therefore, when a replacement frequency of the member increases, production efficiency of the product decreases.

Therefore, the member to be used in the semiconductor production apparatus is required to have a longer lifetime. That is, good plasma resistance is required.

Examples of the semiconductor production apparatus include a plasma etching apparatus.

In the plasma etching apparatus, various members such as a top plate (conductor type), a microwave introduction tube, a lift pin, and various nozzles are used.

As the members, materials such as a cordierite-based sintered body is used in the related art (Patent Literature 1).

### CITATION LIST

### Patent Literature

Patent Literature 1: JPH09-295863A

### SUMMARY OF INVENTION

### Technical Problem

A glass member may be used in the semiconductor production apparatus. In this case, the glass member is also required to have good plasma resistance.

The present invention has been made in view of the above points, and an object of the present invention is to provide a glass member to be used in a semiconductor production apparatus and having excellent plasma resistance.

### Solution to Problem

As a result of intensive studies, the inventors of the present invention have found that the above object can be achieved by adopting the following configurations, and have completed the present invention.

That is, the present invention provides the following [1] to [15].
[1]A glass member for use in a semiconductor production apparatus, including hydrogen in a content of 200 ppm by mass or less.
[2] The glass member according to the above [1], in which the glass member has an average refractive index of 1.5 or more at a wavelength of 365 nm and a difference between an upper limit value and a lower limit value of a refractive index at a wavelength of 365 nm of 0.2 or less.
[3] The glass member according to the above [1] or [2], in which the glass member has a cross-sectional area of 10 cm² or more.
[4] The glass member according to any one of the above [1] to [3], in which the glass member has a ring shape having an outer diameter of 300 mm to 600 mm, an inner diameter of 200 mm to 450 mm, and a thickness of 2 mm to 30 mm, is chamfered at a C of 1.0 or less, has a surface roughness Ra of 1 μm or less, and has a flatness of 0.5 mm or less.
[5] The glass member according to any one of the above [1] to [4], including yttrium and silicon, in which
a molar ratio Y/Si of a content of yttrium to a content of silicon is 0.2 to 1.5.
[1] The glass member according to any one of the above [1] to [5], in which
a content of SiO₂ is 40 mol % to 70 mol %.
a content of Y₂O₃ is 5 mol % to 40 mol %, and
a content of Al₂O₃ is 10 mol % to 30 mol %.
[7] The glass member according to the above [6], in which a content of at least one element a selected from the group consisting of tantalum, boron, magnesium, calcium, strontium, and barium is 10 mol % or less in terms of oxides.
[8] The glass member according to the above [6] or [7], in which a content of at least one element b selected from the group consisting of an alkali metal element, iron, and titanium is 3,000 ppm by mass or less in terms of oxides.
[9] The glass member according to any one of the above [1] to [8], in which the glass member has a Young's modulus of 100 GPa or more and an average thermal expansion coefficient at 50° C. to 350° C. of 4 ppm/K to 7 ppm/K.
[10] The glass member according to any one of the above [1] to [9], in which the glass member has a transmittance of 92% or less at a wavelength of 800 nm.
[11] The glass member according to any one of the above [1] to [10], in which a total number of a bubble having an area of 0.1 mm² or more is 40 or less in arbitrary 10 regions each having an area of 100 mm².
[12] The glass member according to any one of the above [1] to [11], in which an area ratio of a crystal having an area of 0.1 mm² or more is 5% or less in average in arbitrary 10 regions each having an area of 100 mm².
[13] The glass member according to any one of the above [1] to [12], in which the glass member is for use as a focus ring, a shower plate, an electrostatic chuck, a susceptor, an injector, an observation window, a top plate, or a side wall included in the semiconductor production apparatus.
[14] The glass member according to any one of the above [1] to [13], in which an etching rate when etching is performed using a CF₄ gas at a flow rate of 100 sccm is 0.1 or less with respect to quartz.
[15] A method for producing a glass member according to any one of the above [1] to [14], the method including:
melting a glass raw material by heating at a melting temperature of 1,500° C. to 1,800° C.; and
cooling the obtained molten glass to a cooling stop temperature of 700° C. to 900° C. at a cooling rate of 100° C./min to 1.500° C./min.

### Advantageous Effects of Invention

According to the present invention, it is possible to provide a glass member having excellent plasma resistance.

### DESCRIPTION OF EMBODIMENTS

A numerical range represented by using “to” means a range including numerical values described before and after “to” as a lower limit value and an upper limit value.

### [Glass Member]

A glass member according to the present embodiment is a glass member for use in a semiconductor production apparatus, and the glass member contains hydrogen in a content of 200 ppm by mass or less.

Hereinafter, the glass member is also simply referred to as a “glass”, and the glass member according to the present embodiment is also referred to as “the present glass member” or “the present glass”.

The present glass member has excellent plasma resistance. The reasons for this are presumed to be as follows.

First, it is understood that hydrogen contained in the glass member is derived from water molecules, and when the amount of hydrogen is small, the structure of the glass member is dense, and as a result, a rate of deterioration due to plasma irradiation is lowered.

In addition, in the case where fluorine is contained in plasma (or a gas used to generate plasma), hydrogen contained in the glass member easily reacts with fluorine, but since the amount of hydrogen is small, the reaction with fluorine is relatively reduced, and damage to the glass member is prevented.

### <Content of Hydrogen (H Content)>

In the present glass member, the content of hydrogen (also referred to as “H content”) is 200 ppm by mass or less as described above.

For the reason of more excellent plasma resistance, the H content is preferably 150 ppm by mass or less, more preferably 100 ppm by mass or less, still more preferably 50 ppm by mass or less, even more preferably 40 ppm by mass or less, particularly preferably 30 ppm by mass or less, very preferably 20 ppm by mass or less, and most preferably 10 ppm by mass or less.

On the other hand, the H content is, for example, 1 ppm by mass or more, preferably 2 ppm by mass or more, and more preferably 3 ppm by mass or more since it is a realistic value that can be easily controlled in consideration of mass productivity.

The H content in the glass member is determined by secondary ion mass spectrometry (SIMS).

Specifically, the H content is determined using a secondary ion mass spectrometer (model IMS-6f, manufactured by AMETEK. Inc.) under the conditions of primary ion species Cs⁺, a primary acceleration voltage of 15.0 kV, and a detection region of φ 30 μm and a measurement depth of 1 μm.

### <Refractive Index>

### <<Average>>

In the present glass member, an average refractive index at a wavelength of 365 nm (also simply referred to as a “refractive index”) is preferably 1.5 or more, more preferably 1.57 or more, still more preferably 1.63 or more, particularly preferably 1.68 or more, and most preferably 1.7 or more.

Accordingly, the present glass member has more excellent plasma resistance. The reason for this is presumed to be that an element such as yttrium (Y) has good plasma resistance, and a large amount of such an element increases the refractive index of the glass member.

On the other hand, the average refractive index is preferably 1.8 or less, more preferably 1.76 or less, and still more preferably 1.73 or less.

When the average refractive index is within this range, crystallization in the production of the glass member is prevented, and a surface reflectance of the glass member is prevented, so that light from a sensor or the like is easily transmitted.

### <<Difference (Variation) Between Upper Limit Value and Lower Limit Value>>

In the present glass member, a difference (also referred to as a “variation”) between an upper limit value and a lower limit value of the refractive index is preferably 0.2 or less, more preferably 0.05 or less, still more preferably 0.01 or less, even more preferably 0.005 or less, particularly preferably 0.001 or less, very preferably 0.0005 or less, and most preferably 0.0003 or less.

Accordingly, the present glass member has more excellent plasma resistance. The reason for this is presumed to be that, in the case where the refractive index is uniformly and evenly high, a phenomenon that only a part is easily damaged by plasma irradiation hardly occurs, and the plasma resistance is improved as a whole.

Note that, when a size of the glass member is increased, a strength, a composition, and the like may vary depending on a portion, and thus it is advantageous that the plasma resistance is excellent as a whole without a deviation.

### <<Measurement Method>>

The refractive index of the glass member is measured at arbitrary 10 points using a Kalnew precision refractometer KPR-3000 (accuracy: ±0.00002 (23° C.)). An average of the measured values at the 10 points is determined as the average refractive index. In addition, the difference between the upper limit value and the lower limit value of the measured values at the 10 points is obtained as the variation in refractive index (the difference between the upper limit value and the lower limit value).

### <Glass Composition>

Next, the composition (glass composition) of the present glass member is described. That is, contents of elements that may be contained in the present glass member are described.

### <<Si, Y, and Al>>

The present glass member may contain silicon (Si) and yttrium (Y), and may further contain aluminum (Al).

(Molar Ratio Y/Si) A molar ratio (Y/Si) of a content of yttrium (Y) to a content of silicon (Si) is preferably 0.2 or more, more preferably 0.4 or more, and still more preferably 0.5 or more. Accordingly, Y contained in the glass member is relatively increased, and the plasma resistance is more excellent.

On the other hand, the molar ratio (Y/Si) is preferably 1.5 or less, more preferably 1.0 or less, and still more preferably 0.8 or less for the reason that the crystallization during the production of the glass member is prevented.

### (Content of SiO₂)

A content of SiO₂ is preferably 40 mol % or more, more preferably 45 mol % or more, and still more preferably 50 mol % or more.

On the other hand, the content of SiO₂ is, for example, 80 mol % or less, preferably 70 mol % or less, more preferably 65 mol % or less, and still more preferably 60 mol % or less.

(Content of Y₂O₃)

A content of Y₂O₃ is preferably 5 mol % or more, more preferably 10 mol % or more, still more preferably 15 mol % or more, and particularly preferably 20 mol % or more. Accordingly, the refractive index of the glass member is increased, and the plasma resistance is more excellent.

On the other hand, the content of Y₂O₃ is preferably 40 mol % or less, more preferably 35 mol % or less, still more preferably 30 mol % or less, and particularly preferably 25 mol % or less, for the reason that the crystallization during the production of the glass member is prevented.

(Content of Al₂O₃)

A content of Al₂O₃ is preferably 10 mol % or more, more preferably 15 mol % or more, and still more preferably 18 mol % or more, from the viewpoint of improving the strength and heat resistance of the glass member.

On the other hand, the content of Al₂O₃ is preferably 30 mol % or less, more preferably 28 mol % or less, and still more preferably 25 mol % or less, from the viewpoint of obtaining more excellent plasma resistance.

### <<Element a: Ta, B, Mg, Ca, Sr, and Ba>>

The present glass member may contain at least one element a selected from the group consisting of tantalum (Ta), boron (B), magnesium (Mg), calcium (Ca), strontium (Sr), and barium (Ba).

A content of the element a in terms of oxides is preferably 10 mol % or less, more preferably 8 mol % or less, still more preferably 5 mol % or less, even more preferably 3 mol % or less, particularly preferably 1 mol % or less, and most preferably 0 mol %. Note that, the “content of the element a in terms of oxides” in the case where the present glass member contains a plurality of elements as the element a is a sum of contents of the plurality of elements in terms of oxides.

A content of Ta in terms of oxides specifically means a content of Ta₂O₅.

A content of B in terms of oxides specifically means a content of B₂O₃.

A content of Mg in terms of oxides specifically means a content of MgO.

A content of Ca in terms of oxides specifically means a content of CaO.

A content of Sr in terms of oxides specifically means a content of SrO.

A content of Ba in terms of oxides specifically means a content of BaO.

### <<Element b: Alkali Metal Element, Fe, and Ti>>

The present glass member may contain at least one element b selected from the group consisting of an alkali metal element, iron (Fe), and titanium (Ti).

Examples of the alkali metal element include lithium (Li), sodium (Na), potassium (K), rubidium (Rb), cesium (Cs), and francium (Fr). Among these, substantially, lithium (Li), sodium (Na), and potassium (K) are preferred.

However, the element b is an impurity element for the glass member for use in the semiconductor production apparatus and is preferably as small as possible, and specifically, a content of the element b in terms of oxides is preferably 3,000 ppm by mass or less, more preferably 1,000 ppm by mass or less, still more preferably 300 ppm by mass or less, particularly preferably 100 ppm by mass or less, and most preferably 50 ppm by mass or less. Note that, the “content of the element b in terms of oxides” in the case where the present glass member contains a plurality of elements as the element b is a sum of contents of the plurality of elements in terms of oxides.

A content of the alkali metal element (R) in terms of oxides specifically means a content of R₂O.

A content of Fe in terms of oxides specifically means a content of Fe₂O₃.

A content of Ti in terms of oxides specifically means a content of TiO₂.

<<Measurement Method>>

The content (in mol % or mass % in terms of oxides) of each of the above elements (excluding Si) in the glass member is measured using an X-ray fluorescence device (XRF) (ZSX100e manufactured by Rigaku Corporation). That is, an X-ray intensity of each element on a surface of the glass member is measured and quantitatively analyzed to thereby obtain the content of each element.

The content of SiO₂ in the glass member is determined as follows.

First, a powder sample is taken from a center portion of the glass member by polishing, and a total oxygen amount Z1 in the glass member is determined by an infrared absorption method using an oxygen/hydrogen analyzer (ROH-600 manufactured by LECO Corporation). An oxygen amount Z3 is calculated by subtracting an oxygen amount Z2 bound to the elements (excluding Si) contained in the glass member in the stoichiometric composition from the total oxygen amount Z1 in the glass member (oxygen amount Z3=total oxygen amount Z1−oxygen amount Z2).

Assuming that the entire oxygen amount Z3 has been used for bonding with silicon atoms, the oxygen amount Z3 is converted to an amount of SiO₂. The amount of SiO₂ obtained in this manner is set as the content of SiO₂ in the glass member.

### <Young's Modulus>

A Young's modulus of the present glass member is preferably 60 GPa or more, more preferably 80 GPa or more, still more preferably 100 GPa or more, and particularly preferably 110 GPa or more. The present glass member having such a Young's modulus has good dimensional accuracy, less deflection, and excellent thermal shock resistance.

On the other hand, an upper limit of the Young's modulus of the present glass member is not particularly limited, and is, for example, 200 GPa, preferably 180 GPa. and more preferably 160 GPa.

The Young's modulus of the glass member is measured at 25° C. by using an ultrasonic pulse method.

### <Expansion Coefficient>

In a semiconductor production apparatus, the glass member may be used in combination with another member (also referred to as a “peripheral member”), and examples of a material of the peripheral member include SiC and AlN.

An expansion coefficient of the present glass member is preferably close to an expansion coefficient of the material of the peripheral member. Accordingly, the present glass member has an expansion and contraction behavior same as that of the peripheral member, and is prevented from being detached from the peripheral member.

Specifically, an average thermal expansion coefficient of the present glass member at 50° C. to 350° C. (also simply referred to as an “expansion coefficient”) is preferably 4 ppm/K or more, more preferably 4.1 ppm/K or more, still more preferably 4.2 ppm/K or more, and particularly preferably 4.5 ppm/K or more.

On the other hand, the expansion coefficient of the present glass member is preferably 7 ppm/K or less, more preferably 6.5 ppm/K or less, and still more preferably 6 ppm/K or less. The expansion coefficient is measured using a differential thermal expansion meter in accordance with a method described in JIS R 3102-1995.

### <Transmittance>

A glass member having a lower transmittance has more excellent heat insulating properties. Therefore, from the viewpoint of obtaining good heat insulating properties, a transmittance of the present glass member at a wavelength of 800 nm (also simply referred to as a “transmittance”) is preferably 92% or less, more preferably 91% or less, still more preferably 90% or less, even more preferably 89% or less, and particularly preferably 88% or less.

However, depending on an application in the semiconductor production apparatus, the glass member may be required to have a certain degree of transparency. Therefore, from the viewpoint of ensuring good transparency, the transmittance of the present glass member is preferably 80% or more, more preferably 83% or more, and still more preferably 85% or more.

The transmittance is measured for a glass member having a thickness of 2 mm by using a method according to JIS R 3106(1998). That is, the transmittance is a transmittance at a thickness of 2 mm.

### <Number of Bubbles>

The glass member may contain bubbles, and it is preferable that the number of large bubbles is small for the reason of an excellent appearance and more excellent plasma resistance.

Specifically, a total number of a bubble having an area of 0.1 mm² or more (also simply referred to as “the number of bubbles”) in arbitrary 10 regions each having an area of 100 mm² in the glass member is preferably 40 or less, more preferably 30 or less, still more preferably 20 or less, particularly preferably 10 or less, and most preferably 5 or less.

More specifically, a glass member having a plate shape (thickness: 2 mm) is prepared, a photograph of arbitrary region (area: 100 mm²) on a main surface of the glass member is taken using an optical microscope, and the number of bubbles having an area of 0.1 mm² or more is counted from the photograph. The total number of bubbles in arbitrary 10 regions is obtained.

### <Crystal Ratio>

The glass member may contain a crystal (crystal phase), and from the viewpoint of ensuring good transparency, the number of large crystals is preferably small. In addition, from the viewpoint of reducing dust generated when the glass member is exposed to plasma, the number of large crystals is preferably small.

Specifically, in arbitrary 10 regions each having an area of 100 mm² in the glass member, an area ratio of a crystal having an area of 0.1 mm² or more (also referred to as a “crystal ratio” for convenience) is preferably 5% or less, more preferably 3% or less, and still more preferably 1% or less, in terms of average.

More specifically, a glass member having a plate shape (thickness: 2 mm) is prepared, a photograph of arbitrary region (area: 100 mm²) on a main surface of the glass member is taken using an optical microscope, and the area ratio (unit: %) of the crystal having an area of 0.1 mm² or more is measured from the photograph. The average of the area ratios of crystals in arbitrary 10 regions is obtained.

### <Etching Rate>

In the present glass member, an etching rate of the present glass member is preferably 0.1 or less, more preferably 0.05 or less, still more preferably 0.04 or less, even more preferably 0.03 or less, and most preferably 0.02 or less, with respect to quartz when etching is performed using a CF₄ gas at a flow rate of 100 sccm. It can be said that the smaller the etching rate, the more excellent the plasma resistance of the present glass member, and the longer a lifetime of the present glass member. Therefore, a replacement frequency is reduced and a tact of a production apparatus is improved. A lower limit of the etching rate is not particularly limited, and is preferably 0.01 or more from the viewpoint of ease of glass production.

Calculation conditions of the etching rate in the present description are as follows in detail.

### (Calculation Conditions of Etching Rate)

A test piece having a size of 20 mm×20 mm 2 mm is cut out from the glass member, and a surface of 20 mm×20 mm is mirror-finished. A Kapton tape is pasted as a mask to a part of the mirror-finished surface, and etching is performed using a plasma gas under the following conditions.
Apparatus: CCP-RIE
Gas type: CF₄ (100 sccm)
Output: 350 W
Pressure: 10 Pa
Time: 130 minutes
Temperature: 20° C.

Thereafter, an etching amount (wear amount) is determined by measuring a level difference between the etched portion and the non-etched portion by using a stylus surface profiler (Dectak 150, manufactured by ULVAC, Inc.).

Further, the etching amount of the quartz glass is obtained in the same manner.

A ratio of the etching amount of the glass member to the etching amount of the quartz glass is obtained as the etching rate.

### Application

The present glass member is used, for example, as a part or all of each part included in a semiconductor production apparatus (including a semiconductor inspection apparatus).

Examples of each portion included in the semiconductor production apparatus include a focus ring, a shower plate, an electrostatic chuck, a susceptor, an injector (injector nozzle), an observation window (a member for observing the inside from the outside of the semiconductor production apparatus), a top plate, or a side wall (inner wall).

### <Shape and Size>

Examples of a shape of the present glass member include a plate shape (for example, a disc shape and a flat plate shape), a spherical shape (a true spherical shape or a long spherical shape), and a ring shape, and is appropriately selected according to the application.

A size of the present glass member is appropriately selected according to the application.

The present glass member may be increased in size depending on the application, and may have, for example, a cross-sectional area of 10 cm² or more (for example, an area of a cross section parallel to a main surface in the case where the glass member has a plate shape). The cross-sectional area of the present glass member is preferably 100 cm² or more, more preferably 300 cm² or more, and still more preferably 500 cm² or more, from the viewpoint of good versatility.

On the other hand, an upper limit of the cross-sectional area is not particularly limited. However, from the viewpoint of good versatility, it is preferably 5,000 cm² or less, and more preferably 1,000 cm² or less.

In the case where the glass member is used for a focus ring, a susceptor, or the like, the shape thereof is a ring shape.

An outer diameter of the ring-shaped glass member is preferably 300 mm to 600 mm and more preferably 350 mm to 450 mm for the reason that it is suitable for applications such as a focus ring. For the same reason, an inner diameter is preferably 200 mm to 450 mm, and more preferably 250 mm to 350 mm. For the same reason, a thickness is preferably 2 mm to 30 mm, and more preferably 3 mm to 7 mm.

At this time, the ring-shaped glass member is preferably chamfered at a C of 1.0 or less.

In addition, a surface roughness (arithmetic average roughness Ra) of the ring-shaped glass member is preferably 1 μm or less, more preferably 0.1 μm or less, and still more preferably 0.03 μm or less from the viewpoint of preventing dust generation during plasma irradiation and reducing the influence of a thermal stress. The Ra is measured in accordance with JS B 0601:2001.

In addition, a flatness of the ring-shaped glass member is preferably 0.5 mm or less, more preferably 0.1 mm or less, and still more preferably 0.03 mm or less for the reason of good dimensional accuracy. The flatness can be measured by using a non-contact three-dimensional shape measuring device (NH-5Ns manufactured by MITAKA KOHKI Co., Ltd.).

### [Method for Producing Glass Member]

Next, a method for producing the present glass member (hereinafter, also referred to as “the present production method”) is described.

In the present production method, generally, glass raw materials are melted by heating, and the obtained molten glass is annealed.

### <Glass Raw Material>

It is preferable that various glass raw materials are weighed and mixed such that the composition of the glass member to be obtained is the above glass composition.

### <<Use of Oxide>>

As the glass raw materials, an oxide is preferably used without using a hydroxide. Accordingly, an OH amount (H amount) in the glass raw materials is reduced, and thus the H content in the obtained glass member is easily reduced.

However, a sulfur compound may be added to the glass raw materials for the purpose of reducing the number of bubbles contained in the obtained glass member. As the sulfur compound, for example, aluminum sulfate is preferred from the viewpoint of reducing the amount of impurities contained in the obtained glass member.

### <<Water Amount>>

For the reason of easily reducing the H content in the obtained glass member, a water amount contained in the glass raw materials is preferably 200 ppm by mass or less, more preferably 150 ppm by mass or less, still more preferably 100 ppm by mass or less, even more preferably 50 ppm by mass or less, particularly preferably 30 ppm by mass or less, very preferably 25 ppm by mass or less, and most preferably 20 ppm by mass or less. The water amount in the glass raw materials can be adjusted by drying the glass raw materials or the like.

The water amount in the glass raw materials is determined by thermogravimetric analysis (TGA).

It is confirmed.

### <<Mixing Conditions>>

When the glass raw materials are mixed, stirring is preferably performed for 10 minutes or longer under the condition of 10 rpm to 100 rpm using a stirrer. Accordingly, the glass raw materials are sufficiently mixed, and the variation in refractive index of the obtained glass member is easily reduced.

The glass raw materials may be mixed by being charged into a bag, followed by shaking. At this time, it is preferable to shake 100 times or more. Accordingly, the glass raw materials are sufficiently mixed, and the variation in refractive index of the obtained glass member is easily reduced.

### <Melting>

Next, the mixed glass raw materials are heated and melted. At this time, defoaming, homogenization, and the like may be appropriately performed on the molten material by using a known method. In this manner, a molten glass is obtained.

### <<Type of Atmosphere Gas>>

An atmosphere when melting the glass raw materials (also referred to as a “melting atmosphere”) is, for example, air (air atmosphere).

A gas (also referred to as an “atmosphere gas”) may be introduced as the melting atmosphere.

Examples of the atmosphere gas include a nitrogen gas (N₂), an oxygen gas (O₂), compressed air, and water vapor (H₂O), and these may be used alone or in combination of two or more types thereof. In the case of using N₂ and O₂ in combination, a volume ratio (N₂/O₂) thereof is, for example, 8/2.

Among these, at least one selected from the group consisting of N₂, O₂ and compressed air is preferred for the reason of easily reducing the H content in the obtained glass member.

The atmosphere gas may be bubbled into the glass raw materials (molten glass), or may be simply flowed to the surface of a container (a crucible or the like) in which the glass raw materials are contained.

### <<Flow Rate of Atmosphere Gas>>

A flow rate SLM (flow rate per minute at 1 atm and 0° C.) of the atmosphere gas is, for example, 0.1 L/min or more, preferably 1 L/min or more, more preferably 3 L/min or more, still more preferably 5 L/min or more, even more preferably 10 L/min or more, particularly preferably 15 L/min or more, very preferably 20 U/min or more, and most preferably 25 L/min or more.

On the other hand, the flow rate of the atmosphere gas is preferably 60 L/min or less, more preferably 55 L/min or less, still more preferably 50 L/min or less, particularly preferably 45 L/min or less, and most preferably 40 L/min or less.

### <<Temperature of Atmosphere Gas>>

A temperature of the atmosphere gas is preferably 30° C. or higher, more preferably 35° C. or higher, and still more preferably 40° C. or higher, from the viewpoint of keeping the glass melting temperature constant.

On the other hand, the temperature of the atmosphere gas is preferably 100° C. or lower, more preferably 80° C. or lower, and still more preferably 60° C. or lower, from the viewpoint of reducing the production cost.

### <<Melting Temperature>>

A temperature at which the glass raw materials are heated and melted (melting temperature) is preferably 1,500° C. or higher, more preferably 1,550° C. or higher, and still more preferably 1,600° C. or higher. Accordingly, the glass raw materials are sufficiently melted, and the variation in refractive index of the obtained glass member is easily reduced.

On the other hand, the melting temperature is preferably 1,800° C. or lower, more preferably 1,750° C. or lower, and still more preferably 1,700° C. or lower, from the viewpoint of the production cost.

### <<Melting Time>>

A time for heating and melting the glass raw materials (melting time) is preferably 2 hours or longer, more preferably 2.5 hours or longer, and still more preferably 3 hours or longer. Accordingly, the glass raw materials are sufficiently melted, and the variation in refractive index of the obtained glass member is easily reduced. In addition, since the molten glass can be sufficiently refined, the number of bubbles contained in the obtained glass member can be easily reduced.

On the other hand, the melting time is preferably 24 hours or shorter, more preferably 12 hours or shorter, still more preferably 10 hours or shorter, even more preferably 8 hours or shorter, particularly preferably 6 hours or shorter, and most preferably 4 hours or shorter, for the reason of an excellent production cost.

### <<Stirring>>

When the glass raw materials are heated and melted, stirring is preferably performed for 1 hour or longer under the condition of 20 rpm to 60 rpm using a stirrer. Accordingly, the glass raw materials are sufficiently melted, and the variation in refractive index of the obtained glass member is easily reduced.

### <<Water Granulation and Re-Melting>>

The obtained molten glass may be subjected to water granulation once or more, and then the water-granulated product may be melted again. Accordingly, the variation in refractive index of the obtained glass member is easily reduced.

### <Cooling>

Thereafter, the obtained molten glass is cooled.

At this time, the molten glass is preferably cooled (rapidly cooled) from the melting temperature described above to a cooling stop temperature to be described later. Thereafter, the glass is appropriately cooled to room temperature (for example, 25° C.).

### <<Cooling Stop Temperature>>

The cooling stop temperature is, for example, 700° C. to 900° C., and preferably 750° C. to 850° C.

### <<Cooling Rate>>

A cooling rate from the melting temperature to the cooling stop temperature is preferably 100° C./min or more, and more preferably 200° C./min or more, from the viewpoint of reducing the amount of crystals contained in the obtained glass member.

On the other hand, the cooling rate is preferably 1,500° C./min or less, more preferably 1,000° C./min or less, still more preferably 800° C./min or less, and particularly preferably 500° C./min or less from the viewpoint of preventing a variation in glass composition in the obtained glass member and from the viewpoint of easy control when producing the glass member.

Note that, when the cooling rate is within the above range, the variation in glass composition due to thermal convection during flowing-out is prevented, and the variation in refractive index of the obtained glass member is easily reduced.

### <<Molding>>

The molten glass is preferably cooled after being molded into a desired shape.

A molding method is not particularly limited, and examples thereof include a float method, a press method, a fusion method, and a down-draw method. Note that, after the obtained molten glass is molded into a temporary shape and then cooled, the obtained temporarily shaped body may be subjected to processing such as cutting.

### <<Annealing>>

The molded glass may be annealed to remove a strain in the glass.

At this time, for example, the glass is held at any temperature for a certain time, and then cooled to room temperature (for example, 25° C.).

A temperature at which the glass is held (holding temperature) is preferably a temperature near the glass transition point, for example, preferably 700° C. to 1,100° C., and more preferably 850° C. to 950° C., for the reason that the strain can be efficiently removed.

A time for holding the glass at the holding temperature (holding time) is, for example, 1 hour to 10 hours, and preferably 2 hours to 5 hours. The holding time is preferably longer as the shape of the glass is larger and more complicated.

A cooling rate from the holding temperature to room temperature is, for example, 0.1° C./min to 5° C./min, and preferably 0.5° C./min to P° C./min.

In this manner, a glass member having a desired shape is obtained. If necessary, processing such as grinding and polishing may be performed on the obtained glass member.

<<Log η during Flowing-Out>>

A viscosity log η of the molten glass during flowing-out for cooling or the like is preferably 0.5 Pa-s or more. This is because the variation in glass composition due to thermal convection during flowing-out is prevented, and the variation in refractive index of the obtained glass member is reduced.

### EXAMPLES

Hereinafter, the present invention is specifically described with reference to Examples. However, the present invention is not limited to Examples described below.

### Test A: Examples A1 to A11

Hereinafter, Examples A1 to A10 are Inventive Examples, and Example A11 is a Comparative Example.

Glass raw materials were weighed and mixed such that the glass composition of the obtained glass member was SiO₂: 59 mol %, Y₂O₃: 22 mol %, Al₂O₃: 19 mol %. The water amount in the glass raw materials is shown in Table 1 below.

The mixed glass raw materials were charged into a platinum crucible, which was placed in an electric furnace, and melting was performed by heating (melting time: 3 hours) at a melting temperature of 1,600° C. to obtain a molten glass.

An atmosphere gas was introduced into the melting atmosphere under the conditions shown in Table 1 below.

In the case where the melting is performed in the air atmosphere without introducing the atmosphere gas, “air” is described in Table 1 below.

In addition, in the case of using a nitrogen gas (N₂) and an oxygen gas (O₂) in combination at a volume ratio of 8/2 (N₂/O₂), “N₂+O₂” is described in Table 1 below.

The obtained molten glass was cooled from the melting temperature to a cooling stop temperature of 800° C. at a cooling rate of 250° C./min. and then further cooled to room temperature of (25° C.) to obtain a glass member (dimensions: 100 mm×100 mm×15 mm).

The H content and the content of the element b (Na, Fe, and Ti) in the obtained glass member are shown in Table 1 below.

### <Etching Rate>

A test piece having a size of 20 mm×20 mm×2 mm was cut out from the glass member, and a surface of 20 mm×20 mm was mirror-finished. A Kapton tape was pasted as a mask to a part of the mirror-finished surface, and etching was performed using a plasma gas under the following conditions.
Apparatus: CCP-RIE
Gas type: CF₄ (100 sccm)
Output: 350 W
Pressure: 10 Pa
Time: 130 minutes
Temperature: 20° C.

Thereafter, an etching amount (wear amount) was determined by measuring a level difference between the etched portion and the non-etched portion by using a stylus surface profiler (Dectak 150, manufactured by ULVAC, Inc.).

Further, the etching amount of the quartz glass was obtained in the same manner.

A ratio of the etching amount of the glass member to the etching amount of the quartz glass was obtained as the etching rate. The results are shown in Table 1 below.

As the value of etching rate is smaller, it can be evaluated that the plasma resistance is excellent.

TABLE 1

| | Glass raw | | | | | | |
|---|---|---|---|---|---|---|---|
| | materials | Atmosphere gas | | | Glass member | | |
| | Water amount | Type | Flow rate | Temperature | H content | Element b | Etching rate |
| | ppm by mass | — | L/min | ° C. | ppm by mass | ppm by mass | — |
| Ex. A1 | 21 | N₂ | 30 | 50 | 3 | 30 | 0.0213 |
| Ex. A2 | 17 | N₂ | 5 | 80 | 6 | 51 | 0.0219 |
| Ex. A3 | 17 | Air | — | — | 16 | 42 | 0.0224 |
| Ex. A4 | 20 | Compressed | 5 | 50 | 12 | 71 | 0.0223 |
| | | air | | | | | |
| Ex. A5 | 16 | N₂ + O₂ | 0.1 | 50 | 10 | 63 | 0.0221 |
| Ex. A6 | 14 | N₂ + O₂ | 3 | 80 | 9 | 32 | 0.0220 |
| Ex. A7 | 15 | H₂O | 3 | 50 | 22 | 21 | 0.0228 |
| Ex. A8 | 10 | H₂O | 3 | 80 | 30 | 19 | 0.0321 |
| Ex. A9 | 21 | H₂O | 5 | 90 | 87 | 40 | 0.0345 |
| Ex. A10 | 179 | H₂O | 10 | 95 | 113 | 231 | 0.0383 |
| Ex. A11 | 14 | H₂O | 30 | 95 | 215 | 28 | 0.0532 |

### <Conclusion of Evaluation Results>

As shown in Table 1, the glass members in Examples A1 to A10 in which the H content is 200 ppm by mass or less have a smaller value of etching rate and better plasma resistance than the glass member in Example A11 in w % which the H content is more than 200 ppm by mass.

### Test B: Examples B1 to B11

Hereinafter, Examples B1 to B11 are Inventive Examples.

Glass members were obtained in the same manner as in Example A3 of the test A except that the glass raw materials were weighed so as to have the compositions shown in Table 2 below.

In addition, the cooling rate from the melting temperature to the cooling stop temperature was as shown in Table 2 below.

The H content, the average refractive index, the variation in refractive index, the Young's modulus, the expansion coefficient, the transmittance, the number of bubbles, the crystal ratio, and the etching rate in the obtained glass member are shown in Table 2 below.

TABLE 2

| | | Molar | | | | | | | Average | Variation in |
|---|---|---|---|---|---|---|---|---|---|---|
| | Cooling | ratio | | | | | | | refractive | refractive |
| | rate | Y/Si | SiO₂ | Al₂O₃ | Y₂O₃ | B₂O₃ | Ta₂O₅ | H content | index | index |
| | ° C./min | — | mol % | mol % | mol % | mol % | mol % | ppm by mass | — | — |
| Ex. B1 | 300 | 0.4 | 68 | 19 | 12 | — | — | 15 | 1.6387 | 0.0003 |
| Ex. B2 | 250 | 0.6 | 63 | 19 | 18 | — | — | 13 | 1.6855 | 0.0003 |
| Ex. B3 | 250 | 0.6 | 59 | 19 | 18 | — | 4 | 14 | 1.7321 | 0.0002 |
| Ex. B4 | 200 | 0.7 | 59 | 19 | 22 | — | — | 11 | 1.7185 | 0.0001 |
| Ex. B5 | 250 | 0.7 | 59 | 16 | 22 | 3 | — | 13 | 1.7127 | 0.0002 |
| Ex. B6 | 250 | 0.9 | 50 | 25 | 22 | — | 3 | 15 | 1.7573 | 0.0003 |
| Ex. B7 | 200 | 1 | 50 | 25 | 25 | — | — | 14 | 1.7325 | 0.0003 |
| Ex. B8 | 250 | 0.2 | 77 | 16 | 7 | — | — | 15 | Not | Not |
| | | | | | | | | | measurable | measurable |
| Ex. B9 | 250 | 0.2 | 77.4 | 14.4 | 8.2 | — | — | 16 | Not | Not |
| | | | | | | | | | measurable | measurable |
| Ex. B10 | 250 | 1.3 | 43 | 28 | 28 | — | — | 17 | Not | Not |
| | | | | | | | | | measurable | measurable |
| Ex. B11 | 250 | 1.3 | 49 | 18 | 33 | — | — | 12 | Not | Not |
| | | | | | | | | | measurable | measurable |

| | Young's | Expansion | | Number of | | |
|---|---|---|---|---|---|---|
| | modulus | coefficient | Transmittance | bubbles | Crystal ratio | Etching rate |
| | GPa | ppm/K | % | — | % | — |
| Ex. B1 | 107.1 | 4.39 | 89.6 | 4 | 0.1% or less | 0.0424 |
| Ex. B2 | 115.5 | 4.53 | 88.8 | 3 | 0.1% or less | 0.0397 |
| Ex. B3 | 120 | 4.41 | 87.7 | 3 | 0.1% or less | 0.0296 |
| Ex. B4 | 120.04 | 5.76 | 88.0 | 0 | 0.1% or less | 0.0231 |
| Ex. B5 | 118.9 | 5.56 | 88.3 | 2 | 0.1% or less | 0.0304 |
| Ex. B6 | 129.2 | 5.77 | 86.3 | 2 | 0.1% or less | 0.0278 |
| Ex. B7 | 122.3 | 5.98 | 87.2 | 1 | More than 0.1% | 0.0193 |
| | | | | | and 1% or less | |
| Ex. B8 | — | — | 84.4 | 3 | More than 0.1% | 0.0511 |
| | | | | | and 1% or less | |
| Ex. B9 | — | — | 81.4 | 3 | More than 0.1% | 0.0494 |
| | | | | | and 1% or less | |
| Ex. B10 | — | — | 0.35 | Not | 10% or more | 0.0384 |
| | | | | measurable | | |
| Ex. B11 | — | — | 0.01 | Not | 10% or more | 0.0318 |
| | | | | measurable | | |

### <Conclusion of Evaluation Results>

As shown in Table 2, the glass members in Examples B1 to B11 in which the H content is 200 ppm by mass or less have good plasma resistance.

### Test C: Examples C1 to C20

Hereinafter, Examples C1 to C20 are Inventive Examples.

Glass members having the dimensions shown in Table 3 below were obtained in the same manner as in Example A3 of the test A except that the glass raw materials were weighed so as to have the compositions shown in Table 3 below. The surface of the obtained glass member was processed such that the surface roughness (Ra) and the flatness were values shown in Table 3 below.

In addition, the melting time was set to the temperature shown in Table 3 below. In addition, the cooling rate from the melting temperature to the cooling stop temperature was as shown in Table 3 below.

The H content, the average refractive index, the variation in refractive index, the Young's modulus, the expansion coefficient, the transmittance, the number of bubbles, the crystal ratio, and the etching rate in the obtained glass member are shown in Table 3 below.

TABLE 3

| | | | Molar | | | | | | |
|---|---|---|---|---|---|---|---|---|---|
| | Melting | Cooling | ratio | | | | | | |
| | time | rate | Y/Si | SiO₂ | Al₂O₃ | Y₂O₃ | B₂O₃ | Ta₂O₅ | H content |
| | h | ° C./min | — | mol % | mol % | mol % | mol % | mol % | ppm by mass |
| Ex. C1 | 3 | 250 | 0.4 | 68 | 19 | 12 | — | — | 13 |
| Ex. C2 | 3 | 250 | 0.6 | 63 | 19 | 18 | — | — | 15 |
| Ex. C3 | 3 | 250 | 0.7 | 59 | 19 | 22 | — | — | 14 |
| Ex. C4 | 3 | 250 | 0.7 | 59 | 19 | 22 | — | — | 14 |
| Ex. C5 | 3 | 250 | 1 | 50 | 25 | 25 | — | — | 12 |
| Ex. C6 | 3 | 200 | 0.4 | 68 | 19 | 12 | — | — | 12 |
| Ex. C7 | 3 | 200 | 0.6 | 63 | 19 | 18 | — | — | 14 |
| Ex. C8 | 3 | 200 | 0.6 | 63 | 19 | 18 | — | — | 14 |
| Ex. C9 | 3 | 200 | 0.7 | 59 | 19 | 22 | — | — | 15 |
| Ex. C10 | 3 | 200 | 1 | 50 | 25 | 25 | — | — | 11 |
| Ex. C11 | 3 | 180 | 0.4 | 68 | 19 | 12 | — | — | 10 |
| Ex. C12 | 3 | 180 | 0.6 | 63 | 19 | 18 | — | — | 14 |
| Ex. C13 | 3 | 180 | 0.7 | 59 | 19 | 22 | — | — | 15 |
| Ex. C14 | 3 | 180 | 1 | 50 | 25 | 25 | — | — | 13 |
| Ex. C15 | 0.5 | 600 | 0.7 | 59 | 19 | 22 | — | — | 11 |
| Ex. C16 | 3 | 600 | 0.7 | 59 | 19 | 22 | — | — | 14 |
| Ex. C17 | 0.5 | 450 | 0.7 | 59 | 19 | 22 | — | — | 10 |
| Ex. C18 | 3 | 450 | 0.7 | 59 | 19 | 22 | — | — | 8 |
| Ex. C19 | 0.5 | 75 | 0.7 | 59 | 19 | 22 | — | — | 12 |
| Ex. C20 | 3 | 75 | 0.7 | 59 | 19 | 22 | — | — | 9 |

| | Average | Variation in | | | | | |
|---|---|---|---|---|---|---|---|
| | refractive | refractive | Young's | Expansion | | Number of | |
| | index | index | modulus | coefficient | Transmittance | bubbles | Crystal ratio |
| | — | — | GPa | ppm/K | % | — | % |
| Ex. C1 | 1.6385 | 0.0003 | 107.1 | 4.39 | 86.5 | 3 | 0.1% or less |
| Ex. C2 | 1.6856 | 0.0003 | 115.5 | 4.53 | 88.8 | 4 | 0.1% or less |
| Ex. C3 | 1.7185 | 0.0002 | 120.04 | 5.76 | 88.1 | 1 | 0.1% or less |
| Ex. C4 | 1.7185 | 0.0002 | 120.04 | 5.76 | 88.1 | 1 | 0.1% or less |
| Ex. C5 | 1.7324 | 0.0004 | 122.3 | 5.98 | 87.3 | 0 | More than 0.1% |
| | | | | | | | and 1% or less |
| Ex. C6 | 1.6387 | 0.0006 | 107.1 | 4.39 | 86.6 | 4 | 0.1% or less |
| Ex. C7 | 1.6855 | 0.0003 | 115.5 | 4.53 | 88.8 | 6 | 0.1% or less |
| Ex. C8 | 1.6855 | 0.0002 | 115.5 | 4.53 | 88.8 | 2 | 0.1% or less |
| Ex. C9 | 1.7186 | 0.0002 | 120.04 | 5.76 | 88.2 | 1 | 0.1% or less |
| Ex. C10 | 1.7323 | 0.0001 | 122.3 | 5.98 | 87.1 | 1 | More than 0.1% |
| | | | | | | | and 1% or less |
| Ex. C11 | 1.6386 | 0.0007 | 107.1 | 4.39 | 86.5 | 5 | 0.1% or less |
| Ex. C12 | 1.6855 | 0.0004 | 115.5 | 4.53 | 88.9 | 0 | 0.1% or less |
| Ex. C13 | 1.7186 | 0.0002 | 120.04 | 5.76 | 88.0 | 2 | 0.1% or less |
| Ex. C14 | 1.7324 | 0.0009 | 122.3 | 5.98 | 87.4 | 3 | More than 0.1% |
| | | | | | | | and 1% or less |
| Ex. C15 | 1.7182 | 0.0011 | 120.04 | 5.76 | 88.3 | 31 | 0.1% or less |
| Ex. C16 | 1.7185 | 0.0006 | 120.04 | 5.76 | 88.1 | 11 | 0.1% or less |
| Ex. C17 | 1.7184 | 0.0005 | 120.04 | 5.76 | 88.4 | 22 | 0.1% or less |
| Ex. C18 | 1.7184 | 0.0002 | 120.04 | 5.76 | 88.3 | 8 | 0.1% or less |
| Ex. C19 | 1.7185 | 0.0003 | 120.04 | 5.76 | 88.2 | 16 | More than 0.1% |
| | | | | | | | and 1% or less |
| Ex. C20 | 1.7184 | 0.0001 | 120.04 | 5.76 | 88.3 | 0 | More than 0.1% |
| | | | | | | | and 1% or less |

| | Dimension of glass | Ra (after | Flatness (after | Etching |
|---|---|---|---|---|
| | member (before | processing) | processing) | rate |
| | processing) | μm | mm | — |
| Ex. C1 | 200 mm × | 0.01 | 0.02 | 0.0413 |
| Ex. C2 | 200 mm × | 0.01 | 0.02 | 0.0402 |
| Ex. C3 | 20 mm | 0.01 | 0.02 | 0.0223 |
| Ex. C4 | | 0.7 | 0.4 | 0.0261 |
| Ex. C5 | | 0.01 | 0.02 | 0.0186 |
| Ex. C6 | 300 mm × | 0.01 | 0.02 | 0.0451 |
| Ex. C7 | 300 mm × | 0.01 | 0.02 | 0.0423 |
| Ex. C8 | 30 mm | 0.4 | 0.1 | 0.0488 |
| Ex. C9 | | 0.01 | 0.02 | 0.0225 |
| Ex. C10 | | 0.01 | 0.02 | 0.0183 |
| Ex. C11 | φ500 mm × | 0.01 | 0.02 | 0.0455 |
| Ex. C12 | 30 mm | 0.01 | 0.02 | 0.0413 |
| Ex. C13 | | 0.01 | 0.02 | 0.0223 |
| Ex. C14 | | 0.01 | 0.02 | 0.0185 |
| Ex. C15 | 300 mm × | 0.01 | 0.02 | 0.0226 |
| Ex. C16 | 300 mm × | 0.01 | 0.02 | 0.0223 |
| Ex. C17 | 30 mm | 0.01 | 0.02 | 0.0224 |
| Ex. C18 | | 0.01 | 0.02 | 0.0221 |
| Ex. C19 | | 0.01 | 0.02 | 0.0225 |
| Ex. C20 | | 0.01 | 0.02 | 0.0224 |

### <Conclusion of Evaluation Results>

As shown in Table 3, the glass members in Examples C1 to C20 in which the H content is 200 ppm by mass or less have good plasma resistance.

Although various embodiments have been described above, it is needless to say that the present invention is not limited to such examples. It is obvious for a person skilled in the art that various modifications and variations can be made within the scope of claims and it is understood that such modifications and variations naturally belong to the technical scope of the present invention. Further, the components described in the above embodiment may be combined in any manner without departing from the gist of the invention.

Note that, the present application is based on a Japanese Patent Application (No. 2023-068600) filed on Apr. 19, 2023, contents of which are incorporated herein by reference.

1. A glass member for use in a semiconductor production apparatus, comprising hydrogen in a content of 200 ppm by mass or less.

2. The glass member according to claim 1, wherein the glass member has an average refractive index of 1.5 or more at a wavelength of 365 nm and a difference between an upper limit value and a lower limit value of a refractive index at a wavelength of 365 nm of 0.2 or less.

3. The glass member according to claim 1, wherein the glass member has a cross-sectional area of 10 cm² or more.

4. The glass member according to claim 1, wherein the glass member has a ring shape having an outer diameter of 300 mm to 600 mm, an inner diameter of 200 mm to 450 mm, and a thickness of 2 mm to 30 mm, is chamfered at a C of 1.0 or less, has a surface roughness Ra of 1 μm or less, and has a flatness of 0.5 mm or less.

5. The glass member according to claim 1, comprising yttrium and silicon, wherein
a molar ratio Y/Si of a content of yttrium to a content of silicon is 0.2 to 1.5.

6. The glass member according to claim 1, wherein
a content of SiO₂ is 40 mol % to 70 mol %,
a content of Y₂O₃ is 5 mol % to 40 mol %, and
a content of Al₂O₃ is 10 mol % to 30 mol %.

7. The glass member according to claim 6, wherein a content of at least one element a selected from the group consisting of tantalum, boron, magnesium, calcium, strontium, and barium is 10 mol % or less in terms of oxides.

8. The glass member according to claim 6, wherein a content of at least one element b selected from the group consisting of an alkali metal element, iron, and titanium is 3,000 ppm by mass or less in terms of oxides.

9. The glass member according to claim 1, wherein the glass member has a Young's modulus of 100 GPa or more and an average thermal expansion coefficient at 50° C. to 350° C. of 4 ppm/K to 7 ppm/K.

10. The glass member according to claim 1, wherein the glass member has a transmittance of 92% or less at a wavelength of 800 nm.

11. The glass member according to claim 1, wherein a total number of a bubble having an area of 0.1 mm² or more is 40 or less in arbitrary 10 regions each having an area of 100 mm².

12. The glass member according to claim 1, wherein an area ratio of a crystal having an area of 0.1 mm² or more is 5% or less in average in arbitrary 10 regions each having an area of 100 mm².

13. The glass member according to claim 1, wherein the glass member is for use as a focus ring, a shower plate, an electrostatic chuck, a susceptor, an injector, an observation window, a top plate, or a side wall included in the semiconductor production apparatus.

14. The glass member according to claim 1, wherein an etching rate when etching is performed using a CF₄ gas at a flow rate of 100 sccm is 0.1 or less with respect to quartz.

15. A method for producing a glass member according to claim 1, the method comprising:
melting a glass raw material by heating at a melting temperature of 1,500° C. to 1,800° C.; and
cooling the obtained molten glass to a cooling stop temperature of 700° C. to 900° C. at a cooling rate of 100° C./min to 1,500° C./min.
